(19) United States
(12) Patent Application Publication
(10) Pub. No.: US 2025/0229187 A1
(43) Pub. Date: Jul. 17, 2025

(54) APPARATUS AND METHOD FOR INTERACTIVE PLATFORM ACCESS AUTHORIZATION

(71) Applicant: Kidentify Pte Ltd, Sentosa Cove (SG)

(72) Inventors: Kieran Gregory Charles Donovan, Sentosa Cove (SG); Aakash Deep Mandhar, Snoqualmie, WA (US)

(21) Appl. No.: 18/978,570

(22) Filed: Dec. 12, 2024

Related U.S. Application Data
(60) Provisional application No. 63/609,114, filed on Dec. 12, 2023.

(51) Int. Cl. A63F 13/73; A63F 13/79; G06F 21/32; G06V 40/16

(52) U.S. Cl. CPC A63F 13/73; A63F 13/79; G06F 21/32; G06V 40/168; G06V 40/178

(57) ABSTRACT

In an embodiment, a system for interactive platform access authorization is presented. The system may include a camera operable to obtain image data of a user. The system may include a processor in communication with the camera. The processor may be configured to receive the image data from the camera. The processor may be configured to extract facial features from the image data using a facial recognition process. The processor may be configured to determine an age estimation of a user based on the facial features. The processor may be configured to compare the age estimation to an age gate. The processor may be configured to authorize the user to engage with a video game based on the comparison.

### CROSS-REFERENCE TO RELATED APPLICATIONS

This application claims priority to, and the benefit of, U.S. Prov. App. No. 63/609,114, filed Dec. 12, 2023, which is incorporated by reference herein in its entirety.

### TECHNICAL FIELD

This disclosure relates to apparatuses and methods for interactive platforms. In particular, the current disclosure relates to apparatuses and methods for interactive platform access authorization.

### BACKGROUND

Many interactive platforms have parental settings or age-limit restrictions. However, current systems and methods for complying with parental settings or age-limit restrictions are convoluted and lengthy. Modern systems and methods for compliance with age-restricted content/interactions with interactive platforms can be improved.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In an embodiment, a system for interactive platform access authorization is presented. The system may include a camera operable to obtain image data of a user. The system may include a processor in communication with the camera. The processor may be configured to receive the image data from the camera. The processor may be configured to extract facial features from the image data using a facial recognition process. The processor may be configured to determine an age estimation of a user based on the facial features. The processor may be configured to compare the age estimation to an age gate. The processor may be configured to authorize the user to engage with a video game based on the comparison.

In another embodiment, a method of interactive platform access authorization is presented. The method may include receiving, at a processor, image data of a user from a camera in communication with the processor. The method may include extracting, by the processor, facial features from the image data through a facial recognition process. The method may include determining, by the processor, an age estimation of the user based on the facial features. The method may include comparing, by the processor, the age estimation to an age gate. The method may include authorizing the user to engage with a video game based on the comparison.

### BRIEF DESCRIPTION OF THE DRAWINGS

The foregoing aspects and many of the attendant advantages of embodiments of the present disclosure will become more readily appreciated as the same become better understood by reference to the following detailed description, when taken in conjunction with the accompanying drawings.

FIG. 1 illustrates an exemplary embodiment of a block diagram of system for interactive platform access authorization;

FIG. 2 illustrates an exemplary embodiment of a process of creating a virtual avatar;

FIG. 3 is a flowchart for a process of interactive platform access authorization;

FIG. 4 shows a system for interactive platform access authorization with a gaming device;

FIG. 5 shows a system for interactive platform access authorization with a parent device;

FIG. 6 shows a system for interactive platform access authorization with a parent and gaming device;

FIG. 7 shows another system for interactive platform access authorization with a parent and gaming device;

FIG. 8 is a flowchart of a method of interactive platform access authorization; and

FIG. 9 is an embodiment of a computing system that may be implemented with any system, process, or method described herein.

The drawings are not necessarily to scale and may be illustrated by phantom lines, diagrammatic representations, and fragmentary views. In certain instances, details that are not necessary for an understanding of the embodiments or that render other details difficult to perceive may have been omitted.

### DETAILED DESCRIPTION OF EXEMPLARY EMBODIMENTS

Aspects of the present disclosure can be used to provide users with an easy means of interactive platform regulatory compliance. Aspects of the present disclosure may be used to verify ages of users through facial recognition processes. In some embodiments, the present disclosure may be used to modify one or more in-game settings of a video game based on a comparison of an age estimate to an age gate. Age gates may be calculated based on video game ratings, local laws, parents, or other entities. Systems and methods described herein may be used to generate a virtual avatar resembling a user simultaneously as an age estimate of a user is calculated, providing for a more engaging experience. Aspects of the present disclosure may be used to verify a parent or adult figure of a user. Aspects of the present disclosure may also be used in any interactive platform, such as, but not limited to, social media, video games, financial technologies, and other interactive platforms.

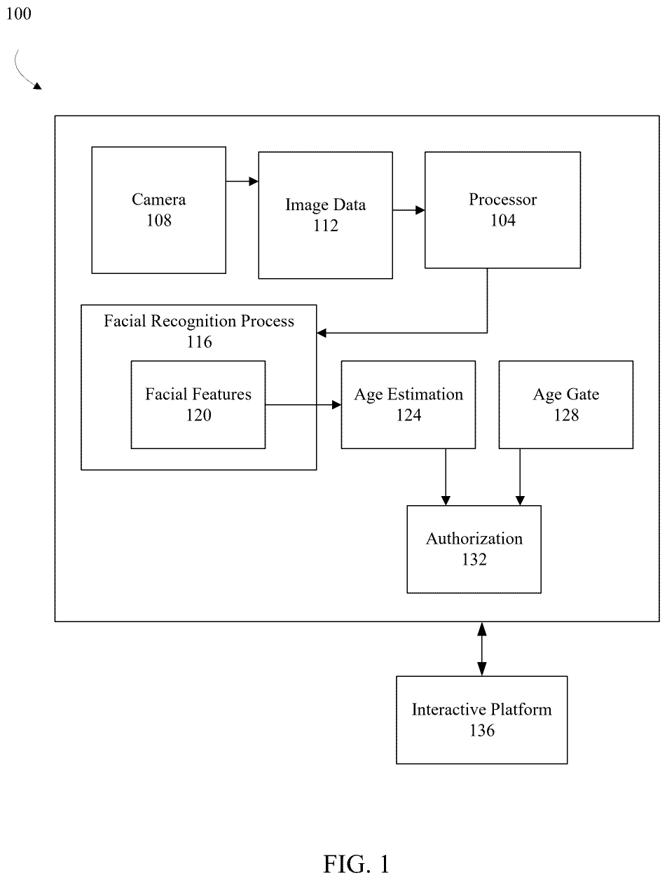

Referring now to FIG. 1, system 100 for interactive platform 136 access authorization is presented. An “interactive platform” as used in this disclosure is any digital environment in which two or more users can interact. Interactive platforms may include, but are not limited to, video games, social media, financial technologies such as but not limited to investment software, educational technologies such as but not limited to online trivia games, and/or other interactive platforms. Interactive platform 136 may include any online environments in which two or more users may interact. In some embodiments, interactive platform 136 may be a single-user experience, such as, but not limited to, a single-player video game. Interactive platform 136 may be accessible through one or more servers, which may host interactive platform 136. In some embodiments, interactive platform 136 may be run locally on a local computing device, such as, but not limited to, a smartphone, tablet, laptop, desktop, console, virtual reality (VR) headset, or other device. Interactive platform 136 may have one or more in-platform options. “In-platform options” as used in this disclosure refers to one or more settings or permissions that adjust a users access to content of an interactive platform. For instance, in-platform options may include, but are not limited to, gore settings, sexual content settings, drug and alcohol use settings, microtransactions, game level access, multiplayer access, downloadable content (DLC) access, social interactivity with one or more other users, and/or other settings or permissions. In-platform options may be set by default by interactive platform 136 based on age restrictions, a user's experience level within interactive platform 136, locational restrictions, or other parameters.

Interactive platform 136 may include any software executable by a PlayStation, Xbox, Nintendo Switch, Steam Deck, iOS device, Android device, Meta Quest device, or any other device capable of providing interactive platform 136 to a user. For instance, and without limitation, interactive platform 136 may take the form of a video game. Interactive platform 136 may be a platforming game, role playing game, first person shooter, third person shooter, looter shooter, fighting game, recreational game, sports game, singe-play game, multi-player game, massive multiplayer online (MMO) game, and/or any other type of video game.

In some embodiments, system 100 may include camera 108. A “camera” as used in this disclosure is any device capable of obtaining an image. Camera 108 may include a smartphone camera, laptop camera, tablet camera, web camera, and/or other camera types. System 100 may include processor 104. Processor 104 may include a microprocessor, system on a chip (SoC), or other type of central processing unit (CPU). Camera 108 may be in communication with processor 104, such as through a wired or wireless connection. Processor 104 and camera 108 may be part of a same computing device, such as a smartphone. In other embodiments, processor 104 and camera 108 may be remote from each other. For instance, processor 104 may be operating on a server or cloud-computing infrastructure. Camera 108 may be operable to generate image data 112. “Image data” as used in this disclosure is any optical information. For instance, and without limitation, image data 112 may include one or more colors, resolutions, aspect ratios, depth fields, and the like. Image data 112 may include one or more photographs, videos, and the like. In some embodiments, image data 112 may include real-time video recordings of an individual.

Processor 104 may extract one or more facial features 120 from image data 112, which may be representative of a facial geometry of an individual. In some embodiments, processor 104 may be configured to detect multiple individuals from image data 112 and may extract facial features 120 from two or more individuals. Facial features 120 may include geometries of cheeks, eyebrows, foreheads, lips, teeth, noses, eyes, and the like. Facial features 120 may include wrinkles, facial hair, tattoos, and/or other features. Processor 104 may use a facial recognition process 116 to identify and/or extract one or more facial features 120 of one or more users. Facial recognition processes 116 may include, any algorithm and/or machine learning model that may be capable of detecting human faces within an image and/or video. Facial recognition process 116 may include any facial recognition software, process, method, or other implementation. Facial recognition process 116 may include a machine learning model trained with training data correlating images of faces to facial features 120 and/or age estimations 124. Training data may be received through user input, external computing device, and/or previous iterations of processing. Facial recognition process 116 may input image data 112 and output one or more facial features 120. In some embodiments, facial recognition process 116 may use facial features 120 to determine age estimation 124. For instance, facial recognition process 116 may compare one or more facial features 120 of a user to one or more facial features 120 of one or more other users with associate age estimations 124. Facial features 120 may be stored in a database in communication with processor 104. A database may include a plurality of facial features 120 corresponding to one or more age estimations 124. In some embodiments, facial recognition process 116 may determine age estimation 124 based on facial features 120. For instance, facial recognition process 116 may include a machine learning model and/or a classifier that may be trained to receive facial features 120 and output age estimations 124. Training data may be received via user input, external computing devices, and/or previous iterations of processing. An “age estimation” as used in this disclosure is a guess of an age of a user. For instance, and without limitation, age estimation 124 may include any age between 1 years old to 100 years old. Age estimation 124 may include a range of ages, limit of ages, and/or other forms of age guesses, such as, but not limited to, “older than 18”, “less than 18 years old”, “older than 21”, or other age estimations 124. For instance and without limitation, age estimation 124 may include an estimation of an age of a user between 8 years old to 12 years old, 12 years old to 15 years old, under 18 years old, under 16 years old, over 18 years old, and/or other ages.

Processor 104 may be configured to compare age estimation 124 with age gate 128. An “age gate” as used in this disclosure is an age limit for a user to have authorization to access with one or more elements of an interactive platform. For instance and without limitation, age gate 128 may include ages of 18 years old, 16 years old, 15 years old, 21 years old, and/or other ages. Processor 104 may be configured to compare age estimation 124 with a particular age gate 128 for a particular authorization 132. For instance, various interactive platforms 136 may have various age gates 128, which processor 104 may be configured to compare age estimation 124 with. In some embodiments, if age estimation 124 meets criteria of age gate 128, processor 104 may provide authorization 132 to a user. “Authorization” as used in this disclosure refers to the process of granting or denying a user access to a system Authorization 132 may be provided to interactive platform 136 in token form, such as an authorization token. In some embodiments, authorization 132 may include grant or denied access to one or more in-platform options of interactive platform 136. In-platform options may include, but are not limited to, posting on social media, investing in a stock, communicating in a Discord channel, playing a video game, playing a virtual reality (VR) video game, and/or any other elements of interactive platforms 136 described throughout this disclosure. In some embodiments, authorization 132 may be for a user to play a video game via interactive platform 136. For instance, if age estimation 124 does not meet criteria of age gate 128, a user may be prohibited from playing a video game by being denied authorization 132. Likewise, if age estimation 124 meets criteria of age gate 128, authorization 132 may allow a user to proceed with playing a video game via interactive platform 136. Authorization 132 may include access to one or more in-game options in embodiments where interactive platform 136 may be a video game. For instance, and without limitation, authorization 132 may include access to in-game chat settings, gore-enablement settings, explicit content toggles, microtransactions, payment methods, skippable levels, in-game parties/worlds, and the like.

In some embodiments, processor 104 may be configured to communicate a comparison of age estimation 124 with age gate 128 to one or more external computing devices. Age estimation 124, age gate 128, and/or a comparison thereof may be communicated to one or more external computing devices through one or more application programming interfaces (APIs). For instance, one or more interactive platforms 136 may communicate with one or more APIs to receive age estimation 124, age gate 128, and/or a comparison thereof. One or more interactive platforms 136 may adjust accessibility of in-game items, voice chats, access to the platform itself, or other features based on age estimation 124, age gate 128, and/or a comparison thereof. In some embodiments, age estimation 124, age gate 128, and/or a combination thereof may be shared among a plurality of interactive platforms 136. Each interactive platform 136 of a plurality of interactive platforms 136 may adjust accessibility to a user based on age estimation 124, age gate 128, and/or a combination thereof.

Still referring to FIG. 1, age gate 128 may be based on one or more regulatory bodies. For instance, age gate 128 may be based on a rating from the Entertainment Software Rating Board (ESRB), such as, but not limited to, E, T, M, AO, and the like. Age gate 128 may alternatively or additionally be based on a location of a user. For instance, processor 104 may obtain an IP addresses, GPS location, and/or other form of geolocation of a user. Based on a location of a user, age gate 128 may be adjusted by processor 104 to be in compliance with local age authorizations for various interactive platforms. Adjustment of age gate 128 may be based on regulatory bodies local to a user. For instance, in some locations, a user may have to be a certain age to be allowed to play a video game or interact with certain in-game settings, while in other locations the user may be allowed to play a video game or interact with certain in-game settings unrestricted. Processor 104 may calculate age gate 128 based at least in part by a location of a user. In some embodiments, age gate 128 may be set by an authorized user, such as, but not limited to, a parental figure. Processor 104 may be configured to override any pre-calculated age gates 128 based on input from an authorized user. For instance, a parental figure may increase or decrease age gate 128 for access to specific interactive platforms 136 and/or in-platform options of interactive platform 136. As a non-limiting example, interactive platform 136 may be a recreational game in which users can interact with each other online, which may have a default age gate 128 of 12 years of age or older. A parental figure may increase age gate 128 to 14 years or older, which may modify determined authorizations 132 for a user to access interactive platform 136. In some embodiments, a plurality of age gates 128 may be calculated and/or used for a plurality of interactive platforms 136 and/or in-platform options of one or more interactive platforms 136. For instance, each age gate 128 of a plurality of age gates 128 may be calculated per specific interactions with a video game, such as, but not limited to, microtransactions, in-game chat settings, and the like. As a non-limiting example a first age gate 128 may be 12 years old for a user to play a video game, but in-chat communications may have a second age gate 128 of 16 years old. In some embodiments, age gate 128 may be sent by a parent or other user. For instance, a parent or other user may set one or more age gates 128 for various forms of media or other content of interactive platform 136, communication channels within interactive platform 136, or other access through interactive platform 136, which may override age gates 128 set by publishers/companies of interactive platform 136. As a non-limiting example, a video game of interactive platform 136 may be rated T for teen and age gate 128 may be 13, however a parent may set age gate 128 to be 18, which may override an original age gate 128 corresponding to the video game.

Processor 104 may be configured to receive data about interactive platform 136 a user may be trying to access from one or more external computing devices or through processor 104. For instance, processor 104 may be configured to receive company names, publication dates, ESRB ratings, content descriptions, and/or any other data describing interactive platform 136 from local databases, online searches, and/or one or more external computing devices, such as, but not limited to, one or more servers that may host interactive platform 136. Based on data received by processor 104 that describes content or other characteristics of interactive platform 136, processor 104 may be configured to calculate age gate 128. In some embodiments, processor 104 may calculate age gate 128 based on a classification of interactive platform 136. For instance, processor 104 may be configured to utilize a classifier. A classifier may be trained with training data categorizing or classifying data of interactive platform 136 to various age gates 128. For instance, video games relating to war may be classified by a classifier as having an age gate 128 of 18 years old, while video games about cooking may be classified to an age gate 128 of about 5 years old. Processor 104 may be configured to classify interactive platforms 136 to various age gates 128 based on, but not limited to, content descriptions, publisher names, company names, average age group associated with an interactive platform, format of interactive platform 136, and/or other data. As a non-limiting example, social media platforms may be classified to an age gate 128 of 16 years old, while online educational trivia games may be classified to an age gate 128 of 12 years old.

With continued reference to FIG. 1, a parental figure may set a user profile for a user, which may include one or more age gates 128 for one or more interactive platforms 136 and/or in-platform options of interactive platform 136. A user profile may be linked to one or more locations, user credentials, names, gamertags, IP addresses, age estimations 124, and/or other data. In some embodiments, processor 104 may automatically generate a user profile as a user is granted or denied permission via authorization 132 to access interactive platform 136 and/or in-game permission of interactive platform 136. For instance, processor 104 may store in a database a user's age estimation 124 and corresponding authorizations 132 for one or more interactive platforms 136 and/or in-game permissions of interactive platforms 136. Processor 104 may determine authorizations 132 for a plurality of interactive platforms 136 based on age estimations 124 of a user and/or age gates 128 associated with one or more interactive platforms 136 of a plurality of interactive platforms 136. In some embodiments, a user may be granted partial access to one or more portions of interactive platform 136 via authorization 132. For instance, in a multi-player game, a user may be granted access to play in single-player mode only, have voice chat disabled, or have certain otherwise playable levels inaccessible based on authorization 132 and/or content of the otherwise playable levels.

In some embodiments, facial recognition process 116 and/or calculation of age estimation 124 may happen remote from processor 104. For instance processor 104 may communicate image data 112 with one or more third parties, severs, external computing devices, and the like. For instance, processor 104 may communicate image data 112 with a server. A server may receive image data 112 and may extract one or more facial features 120 and determine age estimation 124 through a facial recognition process, such as facial recognition process 116. A server may communicate age estimation 124 and/or a comparison of age estimation 124 to age gate 128 to processor 104. Image data 112, facial features 120, and/or age estimation 124 may be communication to one or more third parties, such as through an application programming interface (API). Software developers or other programmers may set age gate 128 via communication with processor 104 through one or more external computing devices, which may allow implementation of age estimation 124 and/or age gate 128 in one or more video games or other forms of interactive platforms 136.

Referring still to FIG. 1, in some embodiments, processor 104 may be configured to generate a virtual avatar of a user. A “virtual avatar” as used in this disclosure refers to a computerized representation of a user. Virtual avatars may be humanoid, animals, robots, aliens, and/or any other visual representation of a user and/or individual. Processor 104 may generate a virtual avatar of a user simultaneously as that of age estimation 124. By generating a virtual avatar simultaneously as performing age estimation 124, a user may be occupied while processor 104 completes its decision on providing authorization 132 to the user, which may reduce a perceived completion time of a determination of authorization 132 to a user. A virtual avatar generated by processor 104 may be customizable by a user. For instance, colors, clothes, limbs, facial features, heights, weights, and/or any other attributes may be customizable by a user. Processor 104 may offload performing age estimation 124 and/or generating a virtual avatar to one or more external computing devices. Processor 104 may utilize one or more facial features 120 to generate a virtual avatar of a user. For instance, a virtual avatar may have similar face structures of a user. A virtual avatar of a user may be generated to represent and/or reflect age estimation 124. For instance, a virtual avatar may look like a teenager, kid, adult, and/or other age group, which may depend on age estimation 124. A virtual avatar may be generated locally to system 100, such as on a smartphone, tablet, laptop, and the like. In some embodiments, processor 104 may be configured to communicate with an interactive platform server and may generate a virtual avatar within interactive platform 136. A virtual avatar generated within interactive platform 136 may be controllable by a user. As a non-limiting example, one or more character models of a specific video game may be used to generate a virtual avatar representing a user, to which the virtual avatar may be usable as a character model within the video game. For instance and without limitation, virtual avatars may be generated within side scroller games, first person shooters, third person shooters, sports games, role playing games, arcade games, recreational games, social media, or any other interactive platforms. In some embodiments, processor 104 may display a virtual avatar to a use through a display in communication with processor 104, such as a smartphone screen, tablet screen, monitor screen, or other display device.

In some embodiments, processor 104 may be configured to verify an identity of a user. For instance, in an embodiment, after calculating age estimate 124, processor 104 may verify a user's identity using a two-step authentication system or other verification method. A two-step authentication system or other verification method may include sending a code to an authoritative figure of a user, such as a parent, via smartphone, laptop, tablet, email address, or other device. In some embodiments, processor 104 may generate one or more texts, e-mails, web links, and the like and may send them to a parental account for verification. Processor 104 may verify a location of a user, such as through an internet protocol (IP) address. For instance, a user may attempt to login to interactive platform 136 with user credentials but may be rejected due to an unauthorized location determined by processor 104. An unauthorized location may be any location determinable by GPS and/or IP tracing that has not been previously authenticated by processor 104. In some embodiments, a user may provide processor 104 with a list of authorized locations from a parental figure or other authorized user. Processor 104 may determine a geolocation of a user and may adjust age gate 128 based on a determined geolocation of a user. For instance, in some cities, states, and/or countries, ages to access interactive platform 136 may vary. Processor 104 may adjust age gate 128 based on local guidelines associated with a geolocation of a user. Local guidelines may be communicated to processor 104 via one or more servers running interactive platform 136 and/or processor 104 may be configured to search online databases to obtain information relating to local guidelines. Local guidelines may include age restrictions related to, but not limited to, tv shows, movies, video games, social media, virtual reality, and/or any other interactive platform.

In some embodiments, processor 104 may be configured to enable a single sign on (SSO) system using age estimate 124 for verification. For instance, a quick-response (QR) code may be generated by processor 104 and may be displayable on a user device, such as a smartphone, laptop, tablet, or other device. A QR code may be scanned by an authorized figure of a user, such as a parent, through a parent device, such as a smartphone, laptop, tablet, or other device. A scanning of a QR code by a parent's device may provide an authorization token to a server in communication with processor 104 or to processor 104 directly which may provide authorization 132 for a user to engage with interactive platform 136 and/or engage with one or more settings of interactive platform 136. In some embodiments, processor 104 may be configured to send one or more push notifications to a parent device, which may include information such as, but not limited to, a time a user attempted to access interactive platform 136, user credentials, user identification, interactive platform 136 name, interactive platform 136 in-platform permissions, and/or other information. A parent may respond to a push notification on their device to approve or deny a request for a user to access interactive platform 136. In some embodiments, a parental device may require biometric identification a personal identification umber (PIN), password, or other verification process to send an approval/denial of authentication 132 to a server and/or processor 104. Upon an approval or denial of from a parental device, which may be communicated to processor 104 from the parental device and/or a server in communication with the parent device and processor 104, processor 104 may be configured to adjust authorization 132. For instance, a parent may provide limited authorization 132 for interactive platform 136.

In some embodiments, processor 104 may determine a history of attempted access to interactive platform 136 by a user. A history of attempted access to interactive platform 136 may include dates, times, locations, user credentials, interactive platform 136 information such as type of interactive platform 136 and/or content of interactive platform 136 and/or other information. Processor 104 may compare a new attempted to access interactive platform 136 with a history of attempted access to determine unusual activity of a user. Unusual activity may be reported to a parental device via processor 104. In some embodiments, processor 104 may provide context alongside a prompt provide authorization 132 for a user. Context may include a last known time a user attempted to access interactive platform 136, previous approval/denials for authorization 132 sent by a parental device, and/or any other information described herein. As a non-limiting example, processor 104 may send a prompt to a parental device that may be for authorization 132 of a user for interactive platform 136, along with information describing that previously the parent had denied authorization 132 for interactive platform 136 for the user. In some embodiments, processor 104 may automatically deny or grant authorization 132 for a user based on a history of approvals and/or denials received by processor 104 from a parent device. For instance, a parent may deny authorization 132 for a user to access interactive platform 136 via a parental device several times, to which processor 104 may automatically deny authorization 132 to interactive platform 136 for a period of time to avoid repeatedly prompting a parental device to approve/deny authorization 132.

System 100 may be implemented as a mobile application, in some embodiments. For instance as an IOS, Android, or other application. A parent may select one or more authorizations 132 of one or more video games settings for a user through a graphical user interface (GUI) in communication with processor 104. For instance there may be slidable icons, toggle icons, and the like of a GUI that may relate to in-platform options such as, but not limited to, voice chat, 18+ voice chat, text chat, mature language, payment methods, and the like. In-platform options of interactive platform 136 adjusted by a parental user may be unchangeable by a user once set. For instance, in-platform options may not be displayed within a GUI of interactive platform 136 and/or may be grayed out, disallowing modification by a user. In some embodiments, a parent may select an experience level of a user through a user interface in communication with processor 104, such as, but not limited to, beginner, advanced, expert, and the like. Based on an experience level, processor 104 may adjust authorization 132 to allow or restrict a user access to various in-platform content.

Processor 104 may adjust one or more authorizations 132 for a user of one or more parts of interactive platform 136, such as gore content, sexual content, drug and alcohol use, and the like. In some embodiments, one or more in-platform options such as communication channels, in-platform stores, gore settings, social network settings, or other in-platform options may be removed from a user's instance of interactive platform 136 based on authorization 132, while other users may have full access to their each individual instance of interactive platform 136, such as in the case of an online game with multiple users or single player games. As a non-limiting example, in a first person shooter, one or more campaign levels may be locked for a user based on authorization 132, while the same one or more levels may be accessed by one or more other users.

In some embodiments, authorization 132 may be for periods of time, such as, but not limited to, minutes, hours, days, weeks, months, or years. A parent may set granted and/or denied authorizations 132 for specific periods of time. In some embodiments, processor 104 may automatically update one or more authorizations 132 based on a tracking of a user's age. For instance, a user may be 14 and may not have authorization 132 to access a specific interactive platform 136, such as an online video game. Processor 104 may determine that a user turned 18, and may now have access to a specific interactive platform 136 via authorization 132 as compared to when the user was 14. In some embodiments, authorization 132 may last for specific periods of in-platform time, such as minutes, hours, days, and the like of a user interacting with an interactive platform. As a non-limiting example, a parent may set an in-platform limit for a video game to about 6 hours of play time a week.

In some embodiments, a user may be a parent or parental figure that may use system 100 to verify they have permissions to provide authorization 132 to a child. For instance, age gate 128 may be 18 years or older. Processor 104 may receive image data 112 from camera 108 of a parent and determine age estimation 124 through facial recognition process 116. If age estimation 124 is within a threshold of age gate 128, authorization 132 may be provided to the parent to modify access to interactive platform 136 for other users. A threshold of age gate 128 may be within a span of about 1 year, 2 years, 3 years, 4 years, 5 years, or greater than about 5 years of age gate 128. Authorization 132 in the case of a parental user may include permissions for the parental user to allow a child to access age-restricted content of interactive platform 136. In some embodiments, a virtual avatar of a parent or parental figure may be created. A virtual avatar of a parent or parental figure may be viewable within interactive platform 136 and may convey information relating to play time, in-platform options, or any other message a parent may set.

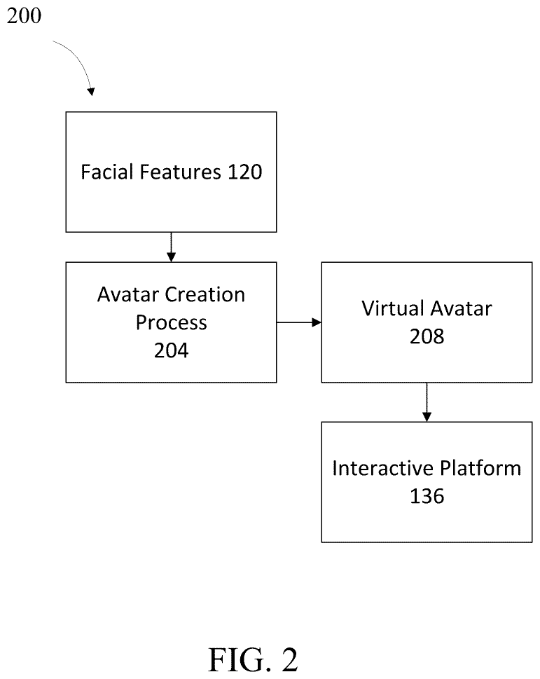

Referring now to FIG. 2, an exemplary embodiment of virtual avatar creation 200 is presented. Virtual avatar creation may happen simultaneously as authentication 132 as described above with reference to FIG. 1. In some embodiments, virtual avatar creation 200 includes utilizing one or more facial features 120, such as described above with reference to FIG. 1. Facial features 120 may be used in avatar creation process 204 to create virtual avatar 208 representing a user. Avatar creation process 204 may include any 3-D character modeling, 2-D character modeling, or other character molding process, without limitation. In some embodiments, virtual avatar creation process 204 may create virtual avatar 208 from scratch. In other embodiments, virtual avatar creation process 204 may create virtual avatar 208 from a selection of one or more base models. A “base model” as used in this disclosure is an originating structure of a virtual avatar from which a virtual avatar may be created. Based models may be specific to age estimations, interactive platforms, content of interactive platforms, a recently created virtual avatar 208, and/or other factors. For instance, avatar creation process 204 may select a kid, teenager, or adult as a base model to create virtual avatar 208 with. In some embodiments, an interactive platform may communicate with a computing device performing virtual avatar creation process 204, which may allow virtual avatar creation process 204 to integrate one or more character models into a creation of virtual avatar 208. In some embodiments, avatar creation process 204 may include a modified version of an in-game avatar creator. Avatar creation process 204 may input one or more facial features 120, such as, but not limited to, checks, cheekbones, noses, eyes, eyebrows, mouths, lips, and the like and may generate virtual representations of these features in virtual avatar 208. Virtual avatar 208 may be a humanoid avatar, in some embodiments. Virtual avatar 208 may be a virtual representation of a user. In some embodiments, virtual avatar 208 may include one or more articles of clothing, such as, but not limited to, shirts, necklaces, earrings, hats, scarves, glasses, and the like. Virtual avatar 208 may be usable in a video game. For instance, virtual avatar 208 may be generated within a video game, such as Roblox. Avatar creation process 204 may happen automatically. In other embodiments, avatar creation process 204 may provide a user with one or more options through a user interface. For instance, avatar creation process 204 may provide options such as, but not limited to, skin colors, heights, weights, nose shapes, articles of clothing, face paint, and the like. Virtual avatar 208 may be modeled after a same age as age estimate 124, as described above with reference to FIG. 1.

Referring still to FIG. 2, virtual avatar 208 may be created within interactive platform 136. Interactive platform 136 may be, but is not limited to, a dancing video game, a social media account, a first person shooter, a third person shooter, a trivia game, a virtual reality game, the Metaverse, and/or any other type of interactive platform 136. Virtual avatar 208 may be created using one or more character creation resources of interactive platform 136. For instance and without limitation, in an embodiment where interactive platform 136 may be a role playing game, virtual avatar 208 may be created using one or more character models, texture packs, movement animations, apparel, apparel texture packs, and/or any other data that may be used to create game character models.

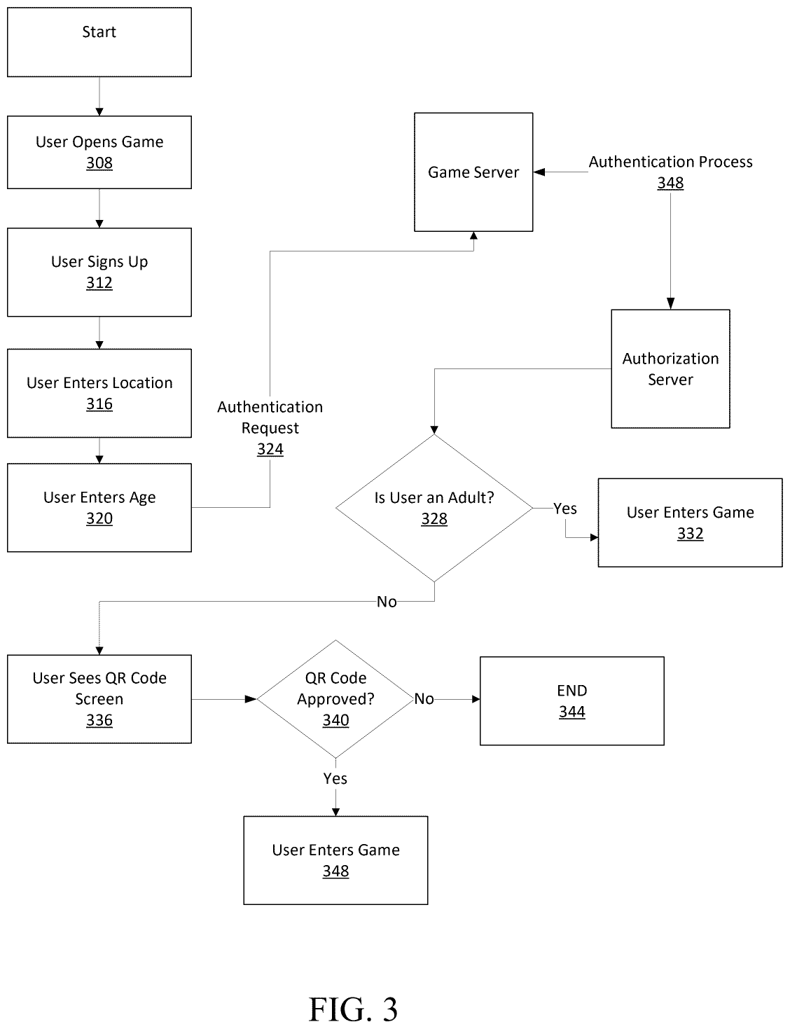

FIG. 3 illustrates a flowchart for a process of interactive platform access authorization. Although the following is described with reference to a video game, other interactive platforms as described throughout this disclosure may be applicable.

At step 304, process 308, process 300 is initiated and a user access a video game. A user may access a video game through a laptop, smartphone, tablet, console, desktop, or other device. For instance, a user may select a video game out of a library of video games through Xbox, PlayStation, Nintendo, or Steam libraries. A user may select a video game through an interactive user interface (UI) via controller, touch, and/or mouse and/or keyboard input. Video games may include, but are not limited to, role playing games, first person shooters, third person shooters, racing games, platforming games, sports games, fighting games, and/or any other type of video game.

At step 312, a user signs up to play the video game selected at step 308. For instance, selection of a video game may trigger a web link pop up or other form of sign up method that a user may have to complete in order to access the selected video game. A sign up form may prompt a user to provide information such as, but not limited to, names, addresses, ages, and/or other information.

At step 316, a user enters their location. A location may be in a street, city, state, country format or any other format. In some embodiments, a location may be automatically determined or preselected via an IP address of a user.

At step 320, a user enters their age. Ages may include any age of a human, such as, but not limited to, between about 4 years old to about 100 years old. A user may enter their numerical age into a sign up form. In some embodiments, an age may be calculated by process 300 via a user providing their date of birth.

At step 324, an authentication request is sent from a user device to a game server. An authentication request may include a request to validate or otherwise confirm the age entered by the user at step 320. A game server may receive an authentication request from a user device, such as through a wireless or wired network. A game server may perform authentication process 348 with an authorization server based on the authentication request 324. Authentication process 348 may include confirming if a user is authorized to play the video game selected in step 308 based on parental permissions and/or an age restricted limitation of a video game. An authorization server may be in communication with a game server and may communicate authentication and/or authorization data to the game server, to which the game server may allow a user to access a selected video game.

At step 328, an authorization server determines if a user is an adult. An authorization server may determine if a user is an adult using age estimation 124 as described above with reference to FIG. 1. An adult may be about or greater than 18 years of age. In some embodiments, authorization server may determine if a user's age is at least an age gate of a selected video game, which may be anywhere between about 5 years old to about 21 years old or greater than about 21 years old. If at step 328 a user is determined by an authorization server to be an adult, the user is authorized to access the selected video game unrestricted at step 332.

If a user is determined to not be an adult and/or not have an age meeting an age gate of the selected video game, an authorization server may provide a QR or other code to a user's device at step 336. A QR code may be provided through a mobile application of a user's device and/or authoritative figure's device. A mobile application may be in communication with an authorization server. A QR or other code may be required to be scanned to verify a user is granted permission to play a selected video game by an authoritative figure, such as a parent. In some embodiments, if a user is determined to not be an adult, a user profile may be created and/or stored in a database in communication with an authorization server.

At step 340, a determination if the QR code sent at step 336 is approved is made. For instance, an authoritative figure, such as a parent, may scan the QR code sent at step 336 with their own device, such as a smartphone, tablet, laptop, or other device. A scanning of a QR code by an authoritative figure's device may provide authentication to an authorization server, which may enable game server to allow a user to enter the selected video game at step 348. Upon scanning the QR code, a request for a user identification (ID) for an authorization server may be sent from an authoritative figure's device. An authorization server may update a user record in an authorization database and may return one or more previously generated user records to an authoritative figure's device. An authoritative figure may add one or more user records to a grouping of user records. An authoritative figure may set a user's game permissions and may send to an authorization server approval or denial permissions for one or more settings of a game. An authorization server may store permissions in an authorization database for a user and may send approved authentication tokens to a game server to authorize a user's gaming session.

In some embodiments, one or more permissions may be sent by an authorization server to a game server. Permissions may include one or more in-game settings, voice chat access, microtransactions, or other permissions relating to a video game. At step 348, one or more permissions may be enabled or disable while allowing a user to enter a selected video game.

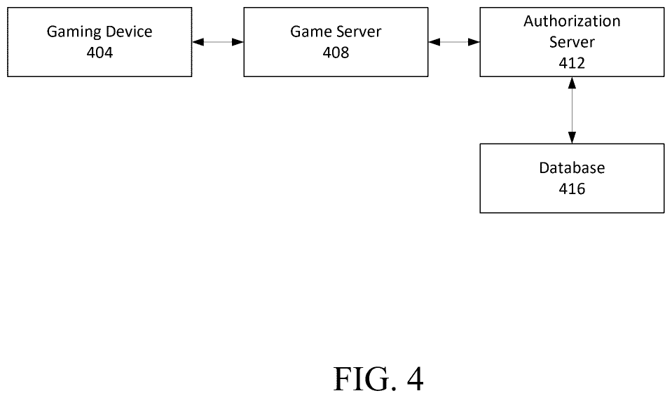

Referring now to FIG. 4, a system 400 with a gaming device 404 is presented. Gaming device 404 may be a handheld device, such as a smartphone, tablet, handheld personal computer (PC), Nintendo switch, or other device. In some embodiments, gaming device 404 may be a laptop, desktop, or console. Gaming device 404 may be in communication with game server 408. Game server 408 may be a computing device that may run one or more video games. Game server 408 may be in communication with authorization server 412. Authorization server 412 may include one or more computing devices that may be configured to authenticate an age of a user, provide permissions for game settings, or perform other functions. In some embodiments, gaming device 404 may communicate an authentication request to game server 408. Game server 408 may request a QR code from authorization server 412. Authorization server 412 may generate and communicate a QR code to game server 408. Game server 408 may communicate a generated QR code to gaming device 404. A second device, such as a device of an authoritative figure, may scan a QR code displayed through gaming device 404, which may authenticate gaming device 404 to play one or more games operated by game server 408. Authorization server 412 may create a user account for a user and may store a user account and corresponding permissions for one or more video games in database 416. In some embodiments, each time a user logs into a game, game server 408 may request updated permissions from authorization server 412. Authorization server 412 may provide game server 408 with an authentication token in response to a request for updated permissions or other authorization. In some embodiments, authorization server 412 and game server 408 may work synchronously, where every time a user attempts to log into a game run by game server 408, game serve 408 first requests permissions from authorization server 412.

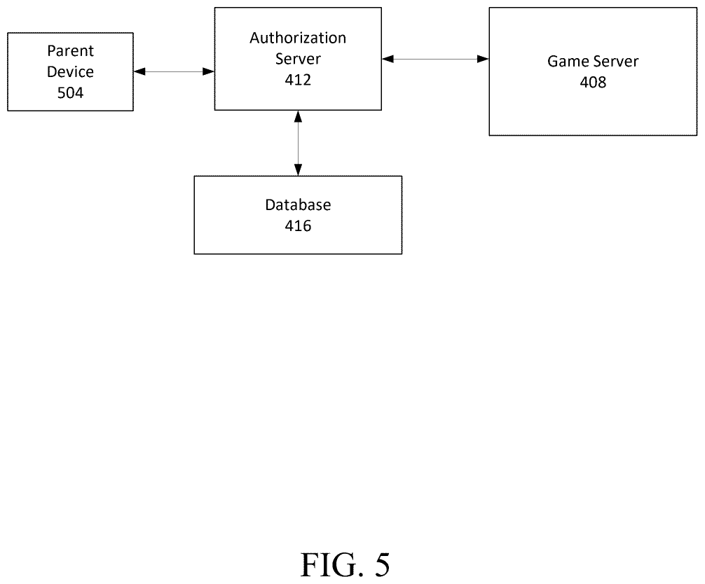

Referring now to FIG. 5, a system 500 with a parent device is presented. Parent device 504 may be a laptop, smartphone, tablet, or any other device. Parent device 504 may be in commination with authorization server 412. Authorization server 412 may be in communication with game server 408 and/or database 416. A parent may change one or more permissions relating to a user's access to one or more interactive platforms, such as a video game. Permissions may include, but are not limited to, in-game voice settings, microtransactions, gore enablement, duration of gaming session, frequency of multiple gaming sessions, friendship requests of one or more other users, limits on content type such as cooking, first person shooters, side scrollers, or other content types, publisher names, or other permissions. A parent may send one or more permissions to authorization server 412. Authorization server 412 may store one or more permissions in data 416. Database 416 may store permissions corresponding to one or more user ID's. User ID's may be gamertags, user names, account profile names, email addresses, and/or any other type of virtual identification. Authorization server 412 may automatically apply one or more permissions to one or more user ID's that correspond to a same user. For instance, a user may have multiple gamertags, usernames, account profile names, or other identification, to which authorization server 412 may apply same or similar permissions set by parent device 504.

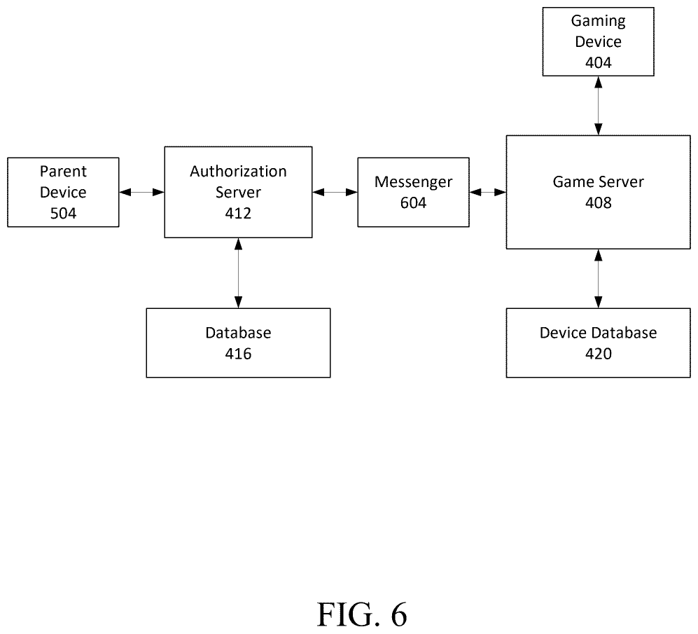

Referring now to FIG. 6, the system of FIG. 5 with a gaming device is presented. Parent device 504 may be in communication with authorization server 412, authorization server 412 may be in communication with database 416, and/or authorization server 412 may be in communication with game server 408, as described above with reference to FIG. 4. Gaming device 404 may be in communication with game server 408. Parent device 504 may send one or more permissions to authorization server 412. Authorization server 412 may order messenger 604 to send a notification to game server 408. A “messenger” as used in this disclosure is software and/or hardware configured to communicate data between two or more computing devices. Messenger 604 may be a server or other computing device that may be configured to communicate data from authorization server 412 to game server 408. Game server 408 may be configured to listen for updates to one or more permissions from messenger 604.

In some embodiments, game server 408 may periodically ping messenger 604 for update from authorization server 412. In other embodiments, game server 408 may wait until messenger 604 actively sends one or more notifications to game server 408. The incorporation of messenger 604 may allow authorization server 412 and game server 408 to work asynchronously. For instance, authorization server 412 may operate independently from game server 408, while messenger 604 may communicate one or more notifications if changes in one or more permissions of authorization server 412 and/or database 416 are identified. By incorporating messenger 604, computational resources and/or network bandwidth of game server 408 may be reduced as compared to a synchronous working of authorization server 412 and game server 408 as described above with reference to FIG. 4. Upon receiving a notification from a messenger, game server 408 may store one or more permissions within itself or device database 420. Device database 420 may be a database that stores data regarding specific gaming devices 404, user ID's, and/or corresponding permissions to access one or more video games. In some embodiments, each time gaming device 404 attempts to access a game of game server 408, gaming device 404 may request permissions stored in game server 408 and/or device database 420. In some embodiments, game server 408 may send in-game reminders to a user to authenticate themselves and/or update permission settings. Reminders may be sent based on a last known updating of one or more permissions, last login time of gaming device 404, updates to one or more games run on game server 408, and/or other criteria. In-game reminders may be text boxes and/or icons overlayed on a UI. In some embodiments, in-game reminders may take form of one or more virtual avatars, virtual objects, or other content within a video game. As a non-limiting example, a specific character may appear and interact with a user's virtual avatar or other character and remind them via text dialogue and/or audio dialogue to update their permissions.

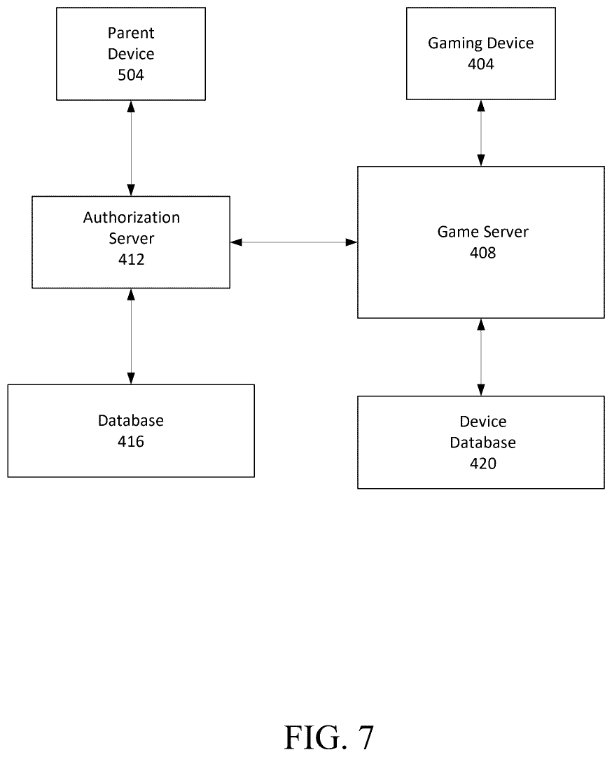

Referring now to FIG. 7, a system for interactive platform access authorization with a parent and gaming device as described above is shown. In some embodiments, each time a user logs into a game via game server 408, game server 408 may request authentication information from authorization server 412 before allowing a user to enter a game. Authentication information may include ages of a user and/or one or more permissions set by parent device 504. Authentication information may be provided to game server 408 by authorization server 412 via a token or other authentication process. Game server 408 may store one or more permissions, user data, interactive platform information, or other data in device database 420. Device database 420 may include information associated with gaming device 404, such as, but not limited to, type of gaming device, user credentials, corresponding permissions for in-platform options/permissions and/or interactive platform permissions, locational data, and/or any other data. In some embodiments, game server 408 may be configured to authorize one or more permissions of gaming device 404 based on stored permissions in device database 420. Game server 408 may be configured to continually update data of device database 420 based on authorization server 412, parent device 504, and/or database 416.

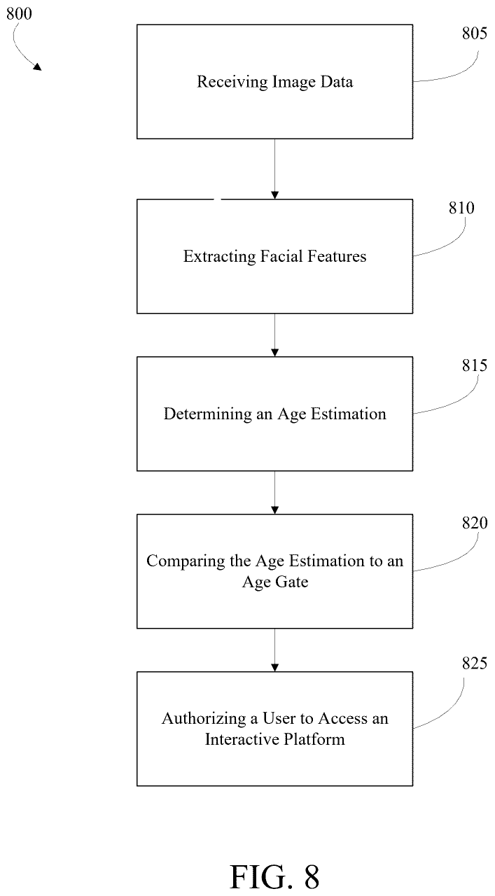

Referring now to FIG. 8, a flowchart of a method 800 of authorizing a user to access an interactive platform is presented. At step 805, method 800 includes receiving image data. Image data may be received by any camera, such as, but not limited to, a smartphone camera, laptop camera, tablet camera, handheld PC camera, or any other camera. Image data may include one or more pixel values, hues, contrasts, colors, depth values, and/or any other image data. This step may be implemented without limitation as described above with reference to FIG. 1.

At step 810, method 800 includes extracting facial features. Facial features may be extracted by a facial recognition process. Facial features may include, but are not limited to, facial geometries, eye brow distance, nose length, and/or other facial features. This step may be implemented without limitation as described above with reference to FIG. 1.

At step 815, method 800 includes determining an age estimation. An age estimation may be determined through a machine learning model. A machine learning model may be trained to input one or more facial features and output one or more age estimations. Age estimations may include any age, without limitation. In some embodiments, age estimations may include a range of ages, such as, but not limited to, about 10-17, about 18-21, or greater than about 21 years old. This step may be implemented without limitation as described above with reference to FIG. 1.

At step 820, method 800 includes comparing the age estimation to an age gate. An age gate may be imposed by a game developer or other software programmer. In some embodiments, an age gate may be calculated based on data of an interactive platform, such as, but not limited to, content type, genre of interactive platform, and/or other data of an interactive platform. This step may be implemented without limitation as described above with reference to FIG. 1.

At step 825, method 800 includes authorizing a user to access an interactive platform. Authorizing a user to access an interactive platform may include allowing the user to enter a video game, social media site, or other interactive platform. In some embodiments, a user may be denied access to an interactive platform, such as if the age estimation is lower than the age gate as compared above in step 820. This step may be implemented without limitation as described above with reference to FIG. 1.

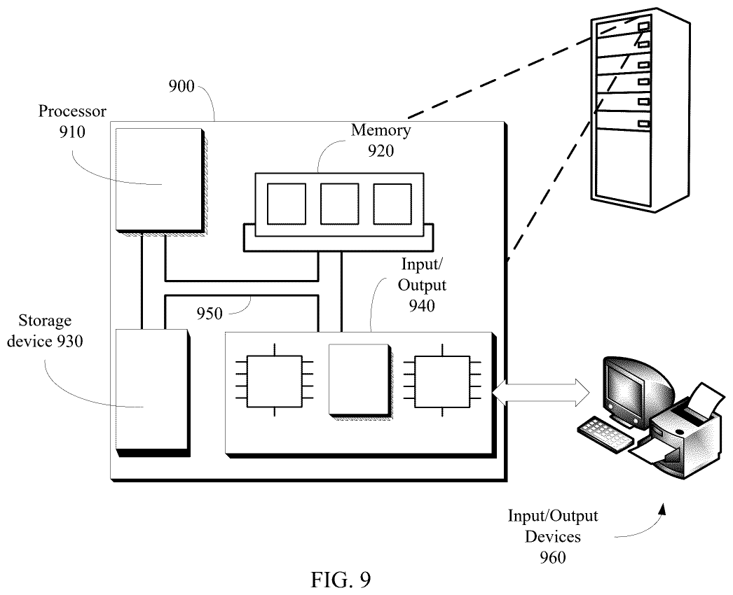

FIG. 9 is a block diagram of an example computer system 900 that may be used in implementing the technology described in this document. General-purpose computers, network appliances, mobile devices, or other electronic systems may also include at least portions of the system 900. The system 900 includes a processor 910, a memory 920, a storage device 930, and an input/output device 940. The apparatus may include disk storage and/or internal memory, each of which may be communicatively connected to each other. The apparatus 100 may include a processor 910. The processor 910 may enable both generic operating system (OS) functionality and/or application operations. In some embodiments, the processor 910 and the memory 920 may be communicatively connected. As used in this disclosure, “communicatively connected” means connected by way of a connection, attachment, or linkage between two or more elements which allows for reception and/or transmittance of information therebetween. For example, and without limitation, this connection may be wired or wireless, direct, or indirect, and between two or more components, circuits, devices, systems, and the like, which allows for reception and/or transmittance of data and/or signal(s) therebetween. Data and/or signals therebetween may include, without limitation, electrical, electromagnetic, magnetic, video, audio, radio, and microwave data and/or signals, combinations thereof, and the like, among others. A communicative connection may be achieved, for example and without limitation, through wired or wireless electronic, digital, or analog, communication, either directly or by way of one or more intervening devices or components. Further, communicative connection may include electrically coupling or connecting at least an output of one device, component, or circuit to at least an input of another device, component, or circuit. For example, and without limitation, via a bus or other facility for intercommunication between elements of a computing device. Communicative connecting may also include indirect connections via, for example and without limitation, wireless connection, radio communication, low power wide area network, optical communication, magnetic, capacitive, or optical coupling, and the like. In some instances, the terminology “communicatively coupled” may be used in place of communicatively connected in this disclosure. In some embodiments, the processor 910 may include any computing device as described in this disclosure, including without limitation a microcontroller, microprocessor, digital signal processor (DSP) and/or system on a chip (SoC) as described in this disclosure. The processor 910 may include, be included in, and/or communicate with a mobile device such as a mobile telephone or smartphone. The processor 910 may include a single computing device operating independently, or may include two or more computing device operating in concert, in parallel, sequentially or the like. Two or more computing devices may be included together in a single computing device or in two or more computing devices. The processor 910 may interface or communicate with one or more additional devices as described below in further detail via a network interface device.

Network interface device may be utilized for connecting the processor 910 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. The processor 910 may include but is not limited to, for example, a computing device or cluster of computing devices in a first location and a second computing device or cluster of computing devices in a second location. The processor 910 may include one or more computing devices dedicated to data storage, security, distribution of traffic for load balancing, and the like. The processor 910 may distribute one or more computing tasks as described below across a plurality of computing devices of computing device, which may operate in parallel, in series, redundantly, or in any other manner used for distribution of tasks or memory between computing devices. The processor 910 may be implemented using a “shared nothing” architecture in which data is cached at the worker, in an embodiment, this may enable scalability of system 900 and/or processor 910.

With continued reference to FIG. 9, processor 910 and/or a computing device may be designed and/or configured by memory 920 to perform any method, method step, or sequence of method steps in any embodiment described in this disclosure, in any order and with any degree of repetition. For instance, the processor 910 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. The processor 910 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Each of the components 910, 920, 930, and 940 may be interconnected, for example, using a system bus 950. The processor 910 is capable of processing instructions for execution within the system 900. In some implementations, the processor 910 is a single-threaded processor. In some implementations, the processor 910 is a multi-threaded processor. In some implementations, the processor 910 is a programmable (or reprogrammable) general purpose microprocessor or microcontroller. The processor 910 is capable of processing instructions stored in the memory 920 or on the storage device 930.

The memory 920 stores information within the system 900. In some implementations, the memory 920 is a non-transitory computer-readable medium. In some implementations, the memory 920 is a volatile memory unit. In some implementations, the memory 920 is a non-volatile memory unit.

The storage device 930 is capable of providing mass storage for the system 900. In some implementations, the storage device 930 is a non-transitory computer-readable medium. In various different implementations, the storage device 930 may include, for example, a hard disk device, an optical disk device, a solid-date drive, a flash drive, or some other large capacity storage device. For example, the storage device may store long-term data (e.g., database data, file system data, etc.). The input/output device 940 provides input/output operations for the system 900. In some implementations, the input/output device 940 may include one or more network interface devices, e.g., an Ethernet card, a serial communication device, e.g., an RS-232 port, and/or a wireless interface device, e.g., an 802.11 card, a 3G wireless modem, or a 4G/5G wireless modem. In some implementations, the input/output device may include driver devices configured to receive input data and send output data to other input/output devices, e.g., keyboard, printer and display devices 960. In some examples, mobile computing devices, mobile communication devices, and other devices may be used.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A system for interactive platform access authorization, comprising:
a camera operable to obtain image data of a user; and
a processor in communication with the camera, the processor configured to:
receive the image data from the camera;
extract facial features from the image data using a facial recognition process;
determine an age estimation of a user based on the facial features;
compare the age estimation to an age gate; and
authorize the user to access an interactive platform based on the comparison.

2. The system of claim 1, further comprising a display in communication with the processor, wherein the processor is further configured to:
generate a virtual avatar of the user based on the age estimation and the extracted facial features; and
display the virtual avatar to the user through the display, wherein the virtual avatar represents the estimated age of the user.

3. The system of claim 2, wherein the virtual avatar is created using a character model specific to a video game.

4. The system of claim 1, wherein the processor is further configured to communicate the comparison through an application programming interface (API) to a third party.

5. The system of claim 1, wherein the age gate is specific to a rating of the interactive platform by the Entertainment Software Rating Board (ESRB).

6. The system of claim 1, wherein the processor is further configured to verify an identity of the user after the comparison based on a two-factor authentication system.

7. The system of claim 1, wherein the processor is further configured to authorize the user based on a location of the user.

8. The system of claim 1, wherein the processor is further configured to communicate the image data with a server, the server operable to:
extract facial features from the image data using a facial recognition process; and
determine an age estimation of a user through the facial recognition process.

9. The system of claim 1, wherein the processor is further configured to adjust the age gate based on a geolocation of the user.

10. The system of claim 1, wherein the processor is further configured to authorize the user to access in in-game communications of the interactive platform based on the comparison.

11. A method of interactive platform access authorization, comprising:
receiving, at a processor, image data of a user from a camera in communication with the processor;
extracting, by the processor, facial features from the image data through a facial recognition process;
determining, by the processor, an age estimation of the user based on the facial features;
comparing, by the processor, the age estimation to an age gate;
authorizing the user to access an interactive platform based on the comparison.

12. The method of claim 11, further comprising:
generating a virtual avatar of the user based on the age estimation and the extracted facial features; and
displaying the virtual avatar to the user through a display, wherein the virtual avatar represents the estimated age of the user.

13. The method of claim 12, wherein the virtual avatar is created using a character model specific to a video game.

14. The method of claim 11, further comprising communicating the comparison through an application programming interface (API) to a third party.

15. The method of claim 11, wherein the age gate is specific to a rating of the interactive platform by the Entertainment Software Rating Board (ESRB).

16. The method of claim 11, further comprising verifying an identity of the user after the comparison through a two-factor authentication system.

17. The method of claim 11, further comprising authorizing the user based on a location of the user.

18. The method of claim 11, further comprising:
communicating the image data with a server;
extracting, at the server, facial features from the image data using a facial recognition process; and
determining, at the server, an age estimation of a user through the facial recognition process.

19. The method of claim 11, further comprising adjusting the age gate based on a geolocation of the user.

20. The method of claim 11, further comprising authorizing the user to engage in in-game communications of the interactive platform based on the comparison.
